(19) United States
(12) Patent Application Publication
(10) Pub. No.: US 2022/0358341 A1
(43) Pub. Date: Nov. 10, 2022

(54) ELECTRONIC TAG ATTACHMENT SYSTEM, ELECTRONIC TAG INSPECTION SYSTEM, AND METHODS FOR SAME

(71) Applicants: DAIO PAPER CORPORATION, Shikokuchuo-shi, Ehime (JP); DAIO ENGINEERING CO., LTD., Shikokuchuo-shi, Ehime (JP)

(72) Inventors: Ryoto TAKAHASHI, Odawara-shi (JP); Shuntaro NOGUCHI, Odawara-shi (JP)

(73) Assignees: DAIO PAPER CORPORATION, Shikokuchuo-shi, Ehime (JP); DAIO ENGINEERING CO., LTD., Shikokuchuo-shi, Ehime (JP)

(21) Appl. No.: 17/619,792

(22) PCT Filed: Jun. 19, 2020
(86) PCT No.: PCT/JP2020/024150

§ 371 Date: Dec. 16, 2021

(30) Foreign Application Priority Data
Jun. 25, 2019 (JP) 2019-117851

(51) Int. Cl. G06K 19/077; B65C 9/26

(52) U.S. Cl. CPC G06K 19/07758; B65C 9/26

(57) ABSTRACT

An electronic tag inspection system including a reading device that reads first identification information written into an electronic tag; an acquisition unit that acquires second identification information on the basis of information retained by an object, which is an object to which the electronic tag is attached; and a detection unit that compares the first identification information and the second identification information, and detects a difference therebetween as a discrepancy between the electronic tag and the object.

### TECHNICAL FIELD

The present invention relates to an electronic tag attachment system, an electronic tag inspection system, and methods for the same.

### BACKGROUND ART

As is well known, an electronic tag (also referred to as an RF tag, an IC tag, an RF label, or the like) includes an IC chip and an antenna connected to the IC chip for performing storage and reading-out of information in a non-contact manner by near field communication. In addition, typically, the electronic tag has an adhesive surface as a rear surface for sticking to objects, or the electronic tag is applied to a product with a string or the like without the adhesive surface. Radio frequency identification (RFID) is an automatic recognition system that performs writing of information relating to the objects to the electronic tag and reading-out of information stored in the electronic tag through radio communication by using the electronic tag.

Various examinations and suggestions have been made on the electronic tag, and some are realized and some are not realized. For example, the electronic tag is expected to be applied to individual product management of products as an alternative to an optically readable tag such as a barcode. In Japan, use of the electronic tag in a specific retail business is known, but currently, the electronic tag is not used in a lot of retail businesses. The main reason for this is that a unit price of the electronic tag is high, but a reading accuracy related problem (blocking of radio waves due to water contained in the content of the product, a metallic product container, or the like), incompletion of a technology of attaching the electronic tag to individual products, and the like also become a hindrance to spreading.

Of these, with regard to the technology of attaching the electronic tag, there is suggested a technology of attaching an electronic tag to which constant information (for example, manufacturing information, track loading information, inventory information, sale information, loss information, delivery information, consumption expiration date information, and consumption information) is written in advance or at the time of attachment to a plurality of the same products (for example, refer to Patent Document 1 to Patent Document 4).

However, in an electronic tag attachment system in the related art, there is a concern that an electronic tag to which information relating to another product is written may be attached to an object product (mismatching), and inspection for the mismatching is not performed. Prevention of the mismatching is very important to realize product management.

For example, it is necessary to attach electronic tags to a wide variety of products as retailers do. In this case, it is realistic to use a common electronic tag attachment system for a plurality of kinds of products and attach an electronic tag to which information corresponding to each of the products is written to the product. However, when using the common electronic tag attachment system, there is a concern that if an object product is changed, mismatching between the electronic tag and the object product may occur. In addition, in the case of a device that performs attachment while replacing the electronic tag to which information is written in advance, there is a concern that mismatching with an object product may occur due to supply of an incorrect electronic tag.

### CITATION LIST

### Patent Document

Patent Document 1: JP-A-2005-104521
Patent Document 2: JP-A-2007-091246
Patent Document 3: JP-A-2007-091298
Patent Document 4: JP-A-2008-044661
Patent Document 5: JP-A-2008-62965

### SUMMARY OF THE INVENTION

### Technical Problem

Here, a main object of the invention is to realize inspection for mismatching between an electronic tag and an object.

### Solution to Problem

An electronic tag inspection system that accomplishes the object, and the like are as follows.

<First Aspect>

An electronic tag attachment system including:

a conveyance line that conveys an object that is an attachment target of an electronic tag;

a tag attachment unit that attaches the electronic tag to which first identification information is written to the object on the conveyance line;

a reading device that reads out the first identification information written to the electronic tag from the electronic tag attached to the object on the conveyance line on a downstream side of the tag attachment unit in the conveyance line;

an acquisition unit that acquires second identification information on the basis of information retained by the object that is the attachment target of the electronic tag from the object on the conveyance line on a downstream side of the tag attachment unit in the conveyance line; and

a detection unit that compares the first identification information and the second identification information and detects a difference therebetween as mismatching between the electronic tag and the object.

(Operational Effect)

This electronic tag attachment system determines suitability of correspondence between the electronic tag and the object that is an attachment target thereof through comparison between the first identification information written to the electronic tag and the second identification information based on information retained by the object. For example, in a case where a barcode including identification information is attached to a product that is an object, when the same identification information as the barcode is written to an electronic tag and the electronic tag is attached to the product, product management using the electronic tag can be performed. In this case, the identification information written to the electronic tag is read out as the first identification information, and the identification information included in the barcode attached to the product is acquired as the second identification information. When two pieces of the identification information do not match each other, it can be determined as mismatching between the electronic tag and the object.

Particularly, in this electronic tag attachment system, the electronic tag is attached to an object on the conveyance line while conveying the object, and then the first identification information and the second identification information are read out. Accordingly, the electronic tag can be continuously attached to a plurality of objects, and inspection for mismatching can be performed. In addition, it is possible not only to sequentially attach a plurality of the electronic tags to which the same first identification information is written in advance, but also to write the first identification information to the electronic tag at the time of attachment.

<Second Aspect>

The electronic tag attachment system according to the first aspect, further including:

a discharge device that discharges the object on a downstream side in comparison to a reading position of the reading device and an acquisition position of the acquisition unit in the conveyance line,

in which when the mismatching is detected by the detection unit, an object of the mismatching is discharged from the conveyance line by the discharge device.

(Operational Effect)

In the first aspect, when detecting the mismatching, the device may also be stopped. However, when the discharge device that discharges the object is provided downstream of the reading position of the reading device and the acquisition position of the acquisition unit in the conveyance line, a mismatched object and a normally attached object can be reliably discriminated, and thus this configuration is preferable.

<Third Aspect>

The electronic tag attachment system according to first or second aspect,

in which the tag attachment unit includes a supply body including a plurality of the electronic tags to which the same first identification information is written, and sequentially attaches the electronic tags of the supply body to the objects, and the supply body is replaceable.

(Operational Effect)

As described above, since the supply body including the plurality of electronic tags to which the same first identification information is written in advance is replaced in correspondence with the kind of the object, in the case of attaching the electronic tag having writing information corresponding to each object, mismatching between the electronic tag and the object is likely to occur due to human error during replacement. Accordingly, it is particularly significant to perform detection of the above-described mismatching in such a case.

<Fourth Aspect>

The electronic tag attachment system according to any one of the first to third aspects,

in which the electronic tag includes an adhesive portion to be stuck to the object,

the electronic tag attachment system has a conveyance line that conveys the object to draw a predetermined movement trajectory,

the tag attachment unit,

sticks the electronic tag to the object at a predetermined sticking position in the conveyance line, and

includes a movement device that moves the sticking position,

a storage unit that stores designation information for designating the object, and the sticking position in association with each other, and

an input device that designates the object, and

a corresponding sticking position is read out from the storage unit in correspondence with the object input by the input device, and the sticking position of the tag attachment unit is automatically changed to the sticking position read out from the storage unit by the movement device.

(Operational Effect)

In the case of sticking electronic tags having the same adhesive portion to a plurality of the same objects on the conveyance line while sequentially conveying the objects on the conveyance line, when conveying the objects to draw a predetermined movement trajectory, and sequentially sticking the electronic tags in a state where a sticking position of the tag attachment unit is fixed in accordance with each of the objects, a simple unit such as a so-called labeler other than a robot can be used as the tag attachment unit, and thus this configuration is preferable. However, in this case, it is necessary to adjust the sticking position of the tag attachment unit whenever the object is changed, and thus the work is complicated. In contrast, in this aspect, since the object is designated when the object is changed, the sticking position of the tag attachment unit can be automatically changed, and device setting can be changed with a very simple operation.

<Fifth Aspect>

An electronic tag attachment system including:

a conveyance line that conveys an object that is an attachment target of an electronic tag;

a tag attachment unit that attaches the electronic tag to which first identification information is written to the object on the conveyance line;

a reading device that reads out the first identification information written to the electronic tag from the electronic tag before being attached to the object;

an acquisition unit that acquires second identification information from the object before attachment of the electronic tag on the basis of information retained by the object that is the attachment target of the electronic tag; and

a detection unit that compares the first identification information and the second identification information and detects a difference therebetween as mismatching between the electronic tag and the object.

(Operational Effect)

As in the first aspect, when the first identification information is read out from the electronic tag attached to the object, it is possible not only to sequentially attach a plurality of the electronic tags to which the same first identification information is written in advance, but also to write the first identification information to the electronic tags at the time of attachment. However, in this case, when detecting mismatching, since each of the electronic tag is already attached to each of the objects, the electronic tag is wasted, and in a case where an exterior of the object is weak, there is a concern that the exterior may be broken when peeling the electronic tag. In contrast, in the case of this aspect, before the electronic tag is attached, mismatching between the electronic tag and the object can be detected, and thus the electronic tag is not wasted, and the concern about the breakage of the exterior of the object also disappears.

<Sixth Aspect>

An electronic tag inspection system including:

a reading device that reads out first identification information written to an electronic tag;

an acquisition unit that acquires second identification information on the basis of information retained by an object that is an attachment target of the electronic tag; and

a detection unit that compares the first identification information and the second identification information and detects a difference therebetween as mismatching between the electronic tag and the object.

(Operational Effect)

This electronic tag inspection system determines suitability of correspondence between the electronic tag and the object that is an attachment target thereof through comparison between the first identification information written to the electronic tag and the second identification information based on information retained by the object. For example, in a case where a barcode including identification information is attached to a product that is an object, when the same identification information as the barcode is written to an electronic tag and the electronic tag is attached to the product, product management using the electronic tag can be performed. In this case, the identification information written to the electronic tag is read out as the first identification information, and the identification information included in the barcode attached to the product is acquired as the second identification information. When two pieces of the identification information do not match each other, it can be determined as mismatching between the electronic tag and the object.

<Seventh Aspect>

An electronic tag attachment method including:

a step of attaching an electronic tag to which first identification information is written to an object;

a reading step of reading out the first identification information written to the electronic tag;

an acquisition step of acquiring second identification information on the basis of information retained by the object that is an attachment target of the electronic tag; and

a detection step of comparing the first identification information and the second identification information and of detecting a difference therebetween as mismatching between the electronic tag and the object.

(Operational Effect)

According to this method, it is possible not only to attach the electronic tag to the object, but also to perform inspection for mismatching between the electronic tag and the object.

<Eighth Aspect>

An electronic tag inspection method including:

a reading step of reading out first identification information written to an electronic tag;

an acquisition step of acquiring second identification information on the basis of information retained by an object that is an attachment target of the electronic tag; and

a detection step of comparing the first identification information and the second identification information and of detecting a difference therebetween as mismatching between the electronic tag and the object.

(Operational Effect)

According to this method, it is possible to perform inspection for mismatching between the electronic tag and the target.

### Advantageous Effects of the Invention

According to the invention, there is an advantage that inspection for mismatching between an electronic tag and an object can be realized, and the like.

### BRIEF DESCRIPTION OF THE DRAWINGS

FIG. 1 is a schematic view of an electronic tag inspection system.

FIG. 2 is a schematic view of an electronic tag attachment system.

FIG. 3 is a schematic view of the electronic tag attachment system.

FIG. 4 is a configuration diagram of a control unit.

FIG. 5 illustrates an example of an electronic tag, in which (a) is a plan view, (b) is a side view, and (c) is a bottom view.

FIG. 6 is a perspective view illustrating an object to which the electronic tag is stuck.

FIG. 7 illustrates an example of the electronic tag, in which (a) is a plan view, (b) is a side view, and (c) is a bottom view.

FIG. 8 is a perspective view illustrating an object to which the electronic tag is stuck.

FIG. 9 is a perspective view of the electronic tag attachment system.

FIG. 10 is a plan view of the electronic tag attachment system.

FIG. 11 is a perspective view of the electronic tag attachment system.

FIG. 12 is a plan view of the electronic tag attachment system.

FIG. 13 is a plan view illustrating a labeler.

FIG. 14 is a right side view illustrating a main portion of the labeler and the like.

FIG. 15 is a right side view illustrating a main portion of the labeler and the like.

FIG. 16 is a right side view schematically illustrating a main portion including a reading device.

FIG. 17 is a front view schematically illustrating a main portion including an acquisition device.

FIG. 18 is a right side view schematically illustrating a main portion including the acquisition device.

### MODE FOR CARRYING OUT THE INVENTION

<Basic Matters>

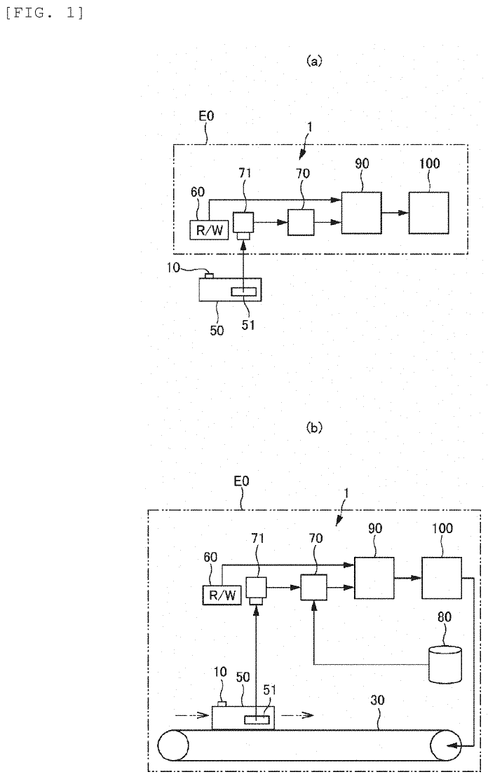

FIG. 1 illustrates an example of an inspection system of an attached electronic tag 10. An electronic tag inspection system 1 includes a reading device 60 that reads out first identification information written to the electronic tag 10, an acquisition unit 70 that acquires second identification information on the basis of information retained by an object 50, a detection unit 90 that compares the first identification information and the second identification information and detects a difference therebetween as mismatching between the electronic tag 10 and the object 50, and a control unit 100 that controls the entirety of the components.

The electronic tag inspection system 1 determines suitability of correspondence between the electronic tag 10 and the object 50 that is an attachment target thereof through comparison between the first identification information written to the electronic tag 10 and the second identification information based on information retained by the object 50. For example, in a case where a barcode including identification information is attached to a product that is the object 50, when the same identification information as the barcode is written to the electronic tag 10, and the electronic tag 10 is attached to the product, product management using the electronic tag 10 can be performed. In this case, the identification information written to the electronic tag 10 is read out as the first identification information, and the identification information included in the barcode attached to the product is acquired as the second identification information, and when the two pieces of information do not match each other, it can be determined as mismatching between the electronic tag 10 and the object 50. Absolutely, in the case of matching, the electronic tag 10 and the object 50 match each other.

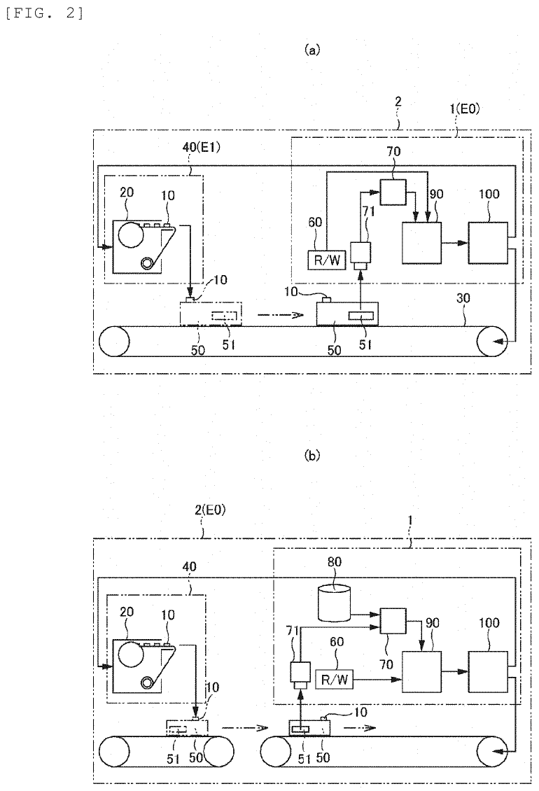

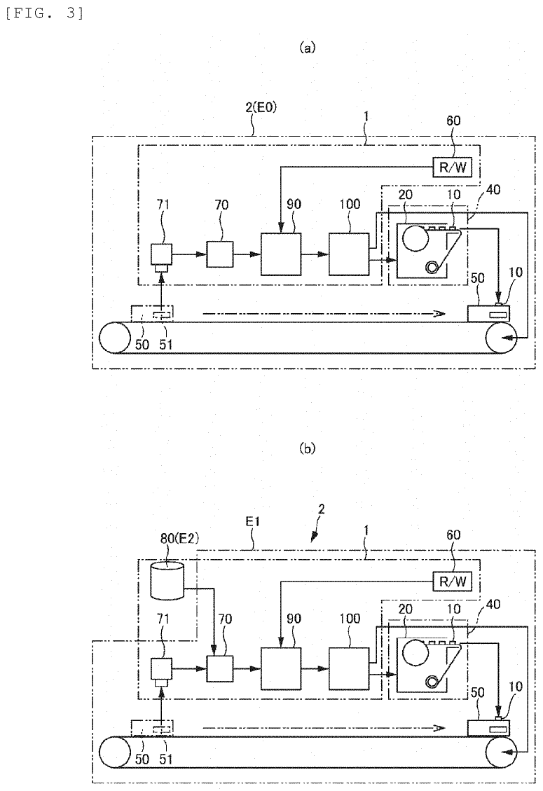

In addition, FIG. 2 and FIG. 3 illustrate an example of an electronic tag attachment system 2 including a tag attachment unit 40 that attaches the electronic tag 10 to which the first identification information is written to the object 50, and the electronic tag inspection system 1.

In the example illustrated in FIG. 2, the reading device 60 reads out the first identification information from the electronic tag 10 attached to the object 50, and the acquisition unit 70 acquires the second identification information from the object 50 after attachment of the electronic tag 10. In this manner, the first identification information is read out after attaching the electronic tag 10 to the object 50, and thus inspection for mismatching between the object 50 and the electronic tag 10 can be easily performed. In addition, it is possible to sequentially attach a plurality of electronic tags 10 to which the same first identification information is written in advance, and it is also possible to write the first identification information to each of the electronic tags 10 at the time of attachment. The acquisition unit 70 may acquire the second identification information from the object 50 before attachment of the electronic tag 10.

On the other hand, in the example illustrated in FIG. 3, the reading device 60 reads out the first identification information from the electronic tag 10 before being attached to the object 50, and the acquisition unit 70 acquires the second identification information from the object 50 before attachment of the electronic tag 10. In the example illustrated in FIG. 2, when the mismatching is detected, the electronic tag 10 is already attached to the object 50. Accordingly, the electronic tag 10 is wasted, and in a case where an exterior of the object 50 is weak, there is a concern that the exterior may be broken when peeling the electronic tag 10. In contrast, in the case of the example illustrated in FIG. 3, suitability of correspondence between the electronic tag 10 and the object 50 can be detected before the electronic tag 10 is attached.

(Control Unit)

The electronic tag inspection system 1 and the electronic tag attachment system 2 including the electronic tag inspection system 1 include the control unit 100 that performs communication with respective constituent elements while performing input and output of information or arithmetic operation as necessary for operations thereof, and controls the respective constituent elements. Accordingly, the control unit 100 can be set to include an input and output device, an arithmetic operation device, a communication device, a storage device, and the like. The control unit 100 can be configured by using a known industrial control device such as a sequencer (PLC) and a computer (PC, a microcontroller) alone, or by combining a plurality of the control devices in correspondence with a function or the like. For example, in the case of an application example to be described later, basic control and an interface of each conveyor of a conveyance line 30, the tag attachment unit 40 (a labeler and a movement device thereof), or the like are realized by the sequencer, information processing or a command (instruction for mode setting, parameter setting, and operation initiation, and the like) with respect to the sequencer based on the information processing can be realized by the computer.

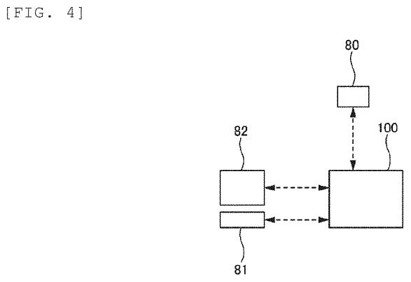

As illustrated in FIG. 4, the control unit 100 includes an input device 81 with which a worker performs input, and can perform various operations (information acquisition, writing, and the like) of the system in correspondence with the input. The input device 81 can be set as a keyboard, a mouse, or a dedicated switch. It is also preferable that a display device 82 configured to display a graphical user interface such as a button for execution of processing is provided in order for the worker to select processing. In this case, it is particularly preferable that a touch panel display including the input device 81 and the display device 82 integrated with each other is provided, and a selection input for processing is performed by touching a processing execution button displayed on the display device 82, or the like as in an application example to be described later. In addition, although not illustrated in the drawing, a portable terminal such as a smartphone including the display device 82 and the input device 81 can be connected to the control unit 100 through a network, near field communication, or wired communication, and processing may be selected by using the display device 82 and the input device 81 of the portable terminal.

(Detection Unit)

The detection unit 90 compares the first identification information input from the reading device 60, and the second identification information input from the acquisition unit 70, and detects a difference therebetween as mismatching between the electronic tag 10 and the object 50. The detection unit is not particularly limited as long as information comparison processing is possible, but it is preferable to be realized by a computer. The detection unit 90 is preferably configured on the same device as in the control unit 100, but may be configured on an additional device. When the mismatching between the electronic tag 10 and the object 50 is detected, it is preferable that the detection unit 90 transmits the detected information to the control unit 100, and the control unit 100 receiving the information stops an operation of the conveyance line or the tag attachment unit 40, or operates a discharge device 35 in an application example to be described later.

(Electronic Tag)

A shape and a structure of the electronic tag 10 are not particularly limited as long as the electronic tag 10 is attached to an object, and a known electronic tag 10 can be appropriately used. For example, in addition to a price tag, a tag, or the like which is externally applied to the object, the electronic tag 10 may be embedded in a container, a lid, a packaging box, or a corrugated cardboard box for transportation of the object. The electronic tag 10 that is externally applied to the object may be fixed or connected to the object by an adhesive surface, a cable, a tag pin, or the like, but may be freely moved without being fixed or connected to the object as long as the electronic tag 10 can be processed (handled) in combination with the object.

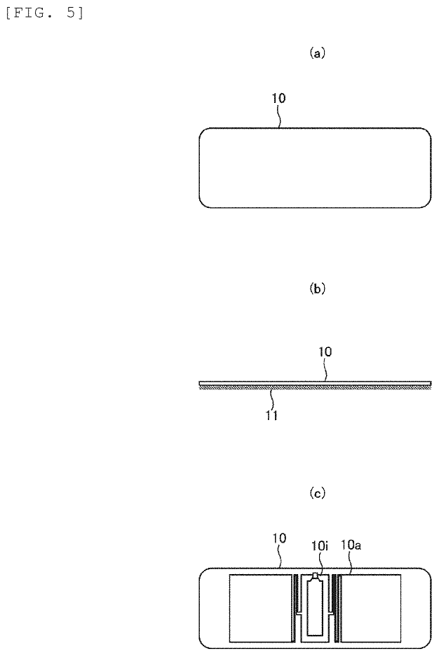

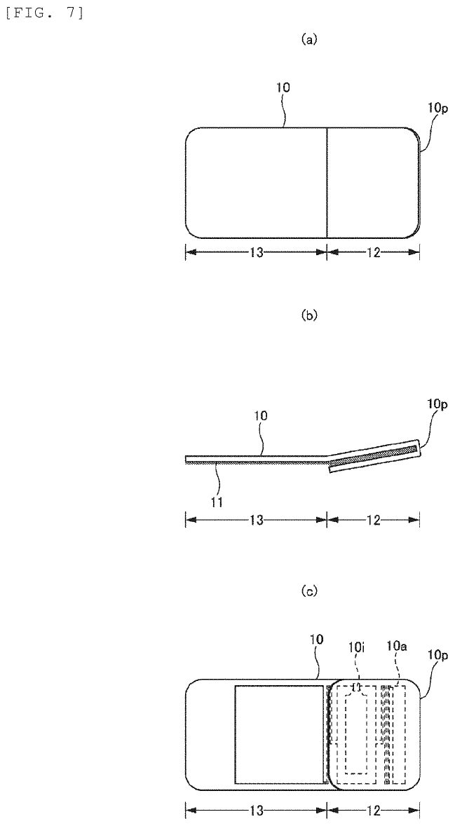

For example, a shape of the electronic tag 10 in a type having the adhesive surface is, typically, a rectangular shape having corners as illustrated in examples illustrated in FIGS. 5(a) to 5(c), or examples illustrated in FIGS. 7(a) to 7(c), but the shape is not limited thereto. In addition, a representative one of the electronic tag 10 is a passive type electronic tag 10 including an IC chip 10i as inlets 10a and 10i and an antenna 10a connected thereto, for example, as illustrated in FIGS. 5(c) and 7(c), but there is no limitation thereto.

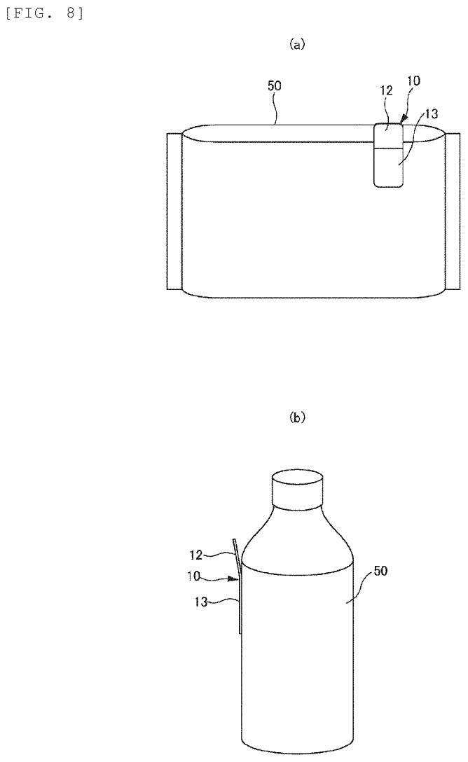

In the electronic tag 10, it is preferable that at least apart of the antenna 10a is spaced apart from sticking objects 50 so as to prevent deterioration of communication quality. For example, in the case of the electronic tag 10 having an adhesive surface 11, as illustrated in FIGS. 7(a) to 7(c), a part of the electronic tag 10 which includes the antenna 10a is folded at a folding position 10p to form a non-adhesive portion 12 in which parts of the adhesive surface 11 are stuck, and a residual adhesive portion 13 in which the adhesive surface 11 is exposed, and the electronic tag 10 can be stuck to the object 50 with the adhesive surface 11 in the residual adhesive portion 13 as illustrated in FIG. 8. Folding of the electronic tag 10 may be performed by a mechanism inside the tag attachment unit 40 in the case of the electronic tag attachment system 2 including the tag attachment unit 40 (for example, refer to Patent Document 5), and the electronic tag 10 of which a part is folded in advance may be supplied to this electronic tag inspection system 1.

(Writing Information)

Writing information of the electronic tag 10 includes the first identification information for identifying the object 50 associated with the electronic tag 10. As the first identification information, product codes such as JAN (EAN), UPC, ISBN, GTIN, and ASIN are suitable, but the first identification information may be a serial number, a model number, a lot number, or the like of a product without particular limitation.

The writing information of the electronic tag 10 may contain another identification information or non-identification information as information other than the first identification information. Examples of the non-identification information include attribute information indicating a characteristics or a property of the object 50 (a color of a product or packaging, a product weight, and the like in addition to information other than a trademark such as a shipping order, a manufacturing date, a consumption expiration date, and a product name), and accessary information (such as time information of time or the like necessary for manufacturing, temperature information of a temperature or the like at the time of manufacturing, humidity information of humidity or the like at the time of manufacturing, random number information relating to fortune telling, lottery, and the like) other than the attribute information.

(Object)

With regard to the object, a shape, a material, an electronic tag attachment method, and the like are not particularly limited as long as the object is an attachment target of the electronic tag. For example, the object may be an item (may be packaged with a box, a bag, a container, or the like, or may not be packaged) that is individually handled such as individual products displayed in a store, or may be packed in a packing material such as a corrugated cardboard box for transportation of one or a plurality of the same or different items.

(Retained Information)

The object 50 has retained information 51 that is also necessary for acquiring the second identification information. The second identification information is formula information that is the same as the first identification information and is information capable of comparing matching and mismatching with respect to the first identification information. Accordingly, in a case where the first identification information is a JAN code, the second identification information is also the JAN code.

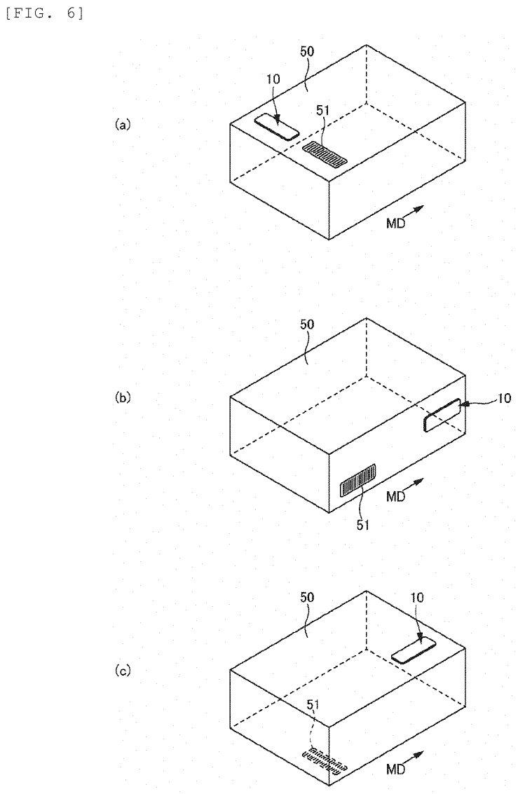

The retained information of the object 50 may be the second identification information itself, or primary information capable of secondarily acquiring the second identification information. It is preferable that the retained information of the object 50 is information applied to the object 50 as a one-dimensional code or a two-dimensional code, or as characters, figures, or the like as is through printing or the like as illustrated in FIG. 6 because the retained information can be easily acquired from the object 50, but there is no limitation thereto.

(Acquisition Unit)

The acquisition unit 70 acquires the retained information 51 itself of the object 50 as the second identification information. In addition to this, the acquisition unit 70 acquires the retained information 51 of the object 50 as primary information, and acquires the second identification information as secondary information on the basis of the primary information.

The acquisition unit 70 includes a retained information sensor 71 that detects the retained information 51 from the object 50, and inputs the detected retained information 51 to the detection unit 90. The retained information sensor 71 is not particularly limited as long as the retained information 51 can be detected from the object 50.

The retained information sensor 71 can be set as at least one of a code reader, an optical character reading device, a magnetic sensor, an NFC communication device, and the like. For example, in a case where the first identification information and the second identification information are set as a product code, and the second identification information is applied to an outer surface of the object 50 as a one-dimensional code or a two-dimensional code, the retained information sensor 71 is set as a code reader of the one-dimensional code, the two-dimensional code, or the like, and the second identification information itself is detected by the retained information sensor 71, and the second identification information is compared with the first identification information to perform inspection for mismatching between the electronic tag 10 and the object 50. Similarly, in a case where the second identification information is applied to the outer surface of the object 50 as a character string such as alphanumeric characters, the retained information sensor 71 is set as the optical character reading device, and the second identification information itself is detected by the retained information sensor 71, and the second identification information is compared with the first identification information to perform inspection for mismatching between the electronic tag 10 and the object 50.

In a case where the object 50 is an object with a magnetic stripe such as a ticket, a check (MICR), a passbook, and a credit card, the retained information sensor 71 is set as the magnetic sensor, and the magnetic recording information can be read out as the retained information 51 of the object 50.

It is preferable that the code reader or the optical character reading device is realized by using an imaging sensor (image sensor) such as a CCD image sensor and a CMOS image sensor. In a method using the imaging sensor, a wide range of detection is possible, and utilization is possible as a multi-purpose reader that detects a plurality of kinds of detection targets. That is, in this case, a one-dimensional code or two-dimensional code, a character, and a color can also be detected with one sensor without forming a sensor for each detection target. Of course, the retained information sensor 71 is not limited to the image sensor, and for example, various known sensors such as a laser scan type can be used in the case of the code reader.

As in an application example to be described later, it is preferable that the retained information sensor 71 is installed in a conveyance line 30 that is used in a process of production and distribution of the object 50, or a conveyance line 30 equipped with the retained information sensor 71 is added to an existing conveyance line 30, and the retained information 51 is detected from the object 50 in conveyance by the conveyance line 30.

In a case where the retained information sensor 71 is set as a handy type device (handy type code reader or the like), at the time of carrying-in, carrying-out, displaying, or the like of the objects 50, a worker can also sequentially detect the retained information 51 of a plurality of the objects 50 by holding the retained information sensor 71 by hands over each of the plurality of the objects 50. In addition, in a case where the retained information sensor 71 is set as a stationary type device, at the time of carrying-in, carrying-out, displaying, or the like of the objects 50, the worker can also sequentially detect the retained information 51 of the plurality of objects 50 by holding each of the objects 50 by hands over the stationary type retained information sensor 71.

For example, the acquisition unit 70 can be constituted by a computer (PC, a microcontroller, a tablet terminal, or a smartphone) provided with the retained information sensor 71 such as the image sensor and the NFC communication device. In addition, it is preferable that the acquisition unit 70 is constituted on the same device as in the detection unit 90 and the control unit 100, but may be constituted on an additional device.

(Storage Unit)

The electronic tag inspection system 1 acquires the retained information 51 of the object 50 as the primary information by the acquisition unit 70, and can be provided with a storage unit 80 that stores the primary information and the secondary information (the second identification information) in association with each other so as to acquire the second identification information as the secondary information on the basis of the primary information. In this case, the acquisition unit 70 detects the retained information 51 of the object 50 by the retained information sensor 71, and acquires the second identification information by reading out the second identification information corresponding to the retained information 51 from the storage unit 80.

The storage unit 80 can be constituted by a network access storage, a cloud storage, the other storage servers, or a database server that is connected through a local network or the Internet in addition to a storage device such as a hard disk and an SSD which are embedded in or externally attached to a device that constitutes the acquisition unit 70, the detection unit or the control unit 100. The storage unit 80 may be a storage unit of a distribution system such as a POS system, a production management system, or the like, or may store information copied from the information of the storage unit of the systems, or information obtained by performing change or addition to the information.

In a case where a plurality of kinds of information are stored, in addition to a configuration in which the storage unit 80 is installed for every kind, a single storage unit 80 that stores all kinds of information may also be installed. For example, in the case of an application example to be described later, it is assumed that the second identification information and sticking position information are stored in a single storage unit 80 in an illustrated example, but there is no limitation thereto.

As in the application example to be described later, the information stored in the storage unit 80 can be read out after being appropriately selected by an input device 81 of the control unit 100.

(Reading Device)

The reading device 60 is configured to read out information written to the electronic tag 10 (a so-called reader/writer), and an installation position thereof or the like can be appropriately determined. For example, in the case of performing reading at a constant distance from the electronic tag 10, the reading device 60 may be installed in a fixed manner in a movement route of the electronic tag 10, and can sequentially perform reading from the electronic tag 10 in movement or in temporarily stoppage. In this case, the electronic tag 10 may be in a state of being attached to the objects 50 or in a state of not being attached to the objects 50. In the former case, the reading device 60 can be installed in the conveyance line 30 that conveys the objects 50 as in the example illustrated in FIG. 1(b) and FIG. 2, and in the latter case, the reading device 60 can be installed in the tag attachment unit 40 as in the example illustrated in FIG. 3.

In the case of performing reading by bringing the reading device 60 close to the electronic tag 10, the reading device 60 is set as a handy type device (handy type code reader or the like), and at the time of carrying-in, carrying-out, displaying, or the like of the objects 50, a worker can sequentially perform reading with respect to a plurality of the electronic tags 10 by holding the reading device 60 by hands over each of the electronic tags 10. The reading device 60 may be supported to be movable by a movement mechanism such as a robot, and reading can also be performed by bringing the reading device 60 close to the electronic tag 10.

In addition, in a case where the reading device 60 is set as a stationary type device, at the time of carrying-in, carrying-out, displaying, or the like of the objects 50, a worker can also sequentially perform reading with respect to a plurality of the electronic tags 10 by holding the objects 50 by hands over the stationary type reading device 60.

A known method can be employed for reading processing by the reading device 60 without particular limitation.

(Tag Attachment Unit)

The electronic tag inspection system 1 may be a single-function device that inspects the object 50 to which the electronic tag 10 is attached in advance only for mismatching or not as in the example illustrated in FIG. 1, or may be provided in the electronic tag attachment system 2 including the tag attachment unit 40 that attaches the electronic tag 10 to which the first identification information is written as in the example illustrated in FIG. 2 and FIG. 3. In the case of the electronic tag 10 having the adhesive surface 11, as the tag attachment unit 40, a labeler 20 in the application example to be described later, or the other known sticking devices (for example, a robot described in Patent Document 4, or the like) can be employed. The tag attachment unit 40 may be a handy type sticking device (handy labeler) configured to perform sticking of the electronic tag 10 when a worker presses the tag attachment unit 40 against the object 50 with hands. In the case of the electronic tag 10 that does not have the adhesive surface 11, the tag attachment unit 40 may be a tagging device that attaches the electronic tag 10 to the objects 50 such as clothes through a cable, a tag pin, or the like, or may be an insertion device that inserts the electronic tag 10 into a packaging box of products. The attachment of the electronic tag 10 to the objects 50 can be manually performed by a worker.

(Device Configuration)

In each of the electronic tag inspection system 1 and the electronic tag attachment system 2, all constituent elements may be integrated as one device, or a plurality of devices constituted by one or a plurality of constituent elements may be combined. Particularly, as in constituent elements of the acquisition unit 70, the detection unit 90, the control unit 100, the storage unit 80, and the like, it is preferable that in constituent elements which can be constructed as a combination of hardware or software on one device, some or all of the constituent elements are constructed on one device. In addition, unidirectional or bidirectional communication (including communication through a network in addition to communication without through a network) can be established for some or all of the constituent elements in a wired or wireless manner so as to cooperate as a whole. In addition, some of the constituent elements may operate independently from the other constituent elements.

Each of the electronic tag inspection system 1 and the electronic tag attachment system 2 may be one handy type device as a whole, or may be a stationary type device to a certain extent capable of being installed on a desk, or to a certain extent of a register in a retail store. In addition, as in the application example to be described later, the electronic tag inspection system 1 and the electronic tag attachment system 2 may be larger device including conveyors 31 to 33 or the labeler 20. In addition, in a case where the electronic tag inspection system 1 is constituted by a plurality of devices, and in a case where the electronic tag attachment system 2 is constituted by a plurality of devices, each of the devices may be a handy type device, may be a stationary type device to a certain extent capable of being installed on a desk or to a certain extent of a register in a retail store, or may be a larger device.

Hereinafter, a specific example of the device configuration and the like will be described.

### First Example

FIG. 1 illustrates an example of the electronic tag inspection system 1. As described above, this example is provided with the reading device 60 that reads out the first identification information written to the electronic tag 10, the acquisition unit 70 that acquires the second identification information on the basis of information retained by the objects 50, the detection unit 90 that compares the first identification information and the second identification information and detects a difference therebetween as mismatching between the electronic tag 10 and each of the objects 50, and the control unit 100 that controls the entirety of the components.

In the first example, the acquisition unit 70 may be anyone described above, but in an example illustrated in FIG. 1(a), the retained information 51 itself of the object 50 is acquired as the second identification information by the retained information sensor 71. On the other hand, in an example illustrated in FIG. 1(b), the acquisition unit 70 acquires the retained information 51 of the object 50 as the primary information by the retained information sensor 71, and the second identification information as the secondary information is acquired from the storage unit 80 on the basis of the primary information. In the case of this example, a stationary type one device E0 is preferable as a whole, but the storage unit 80 can be set as another device and can also be installed to be spaced apart from the other devices.

As illustrated in FIG. 1(a), the system in the first example is set as a handy type or stationary type single device E0 as a whole, and the first identification information and the second identification information can be acquired by manually bringing the corresponding device and the object close to each other by a worker. In this case, both the first identification information and the second identification information can be simultaneously or sequentially acquired by the device E0, and in each acquisition, the detection unit 90 can automatically detect mismatching or matching between the electronic tag 10 and the object 50, and the result (at least mismatching) can be output to an output device such as the display device 82 by the control unit 100.

In addition, as in the example illustrated in FIG. 1(b), the system may be set as the stationary type single device E0 as a whole, the conveyance line 30 that conveys the objects 50 may be installed, the reading device 60 and the acquisition unit 70 may be installed in the conveyance line 30, and the first identification information and the second identification information may be automatically acquired from the objects 50 conveyed on the conveyance line 30. In this case, both the first identification information and the second identification information can be simultaneously or sequentially acquired from the objects 50 on the conveyance line 30 while conveying the objects 50, and in each acquisition, the detection unit 90 can automatically detect mismatching or matching between the electronic tag 10 and the objects 50, and the result can be output to an output device such as the display device 82 by the control unit 100. In addition to this, when mismatching is detected by the detection unit 90, the conveyance line 30 can be stopped by the control unit 100. In the electronic tag inspection system 1 including the conveyance line 30, as in the application example to be described later, a discharge device 35 that discharges the objects 50 may be installed downstream of a reading position of the reading device 60 and an acquisition position of the acquisition unit 70 in the conveyance line 30, and when mismatching is detected by the detection unit 90, an object 50 of the mismatching may be discharged from the conveyance line 30.

In the example illustrated in FIG. 1, the first identification information and the second identification information are acquired from the object 50 to which the electronic tag 10 is attached, but the first identification information may be read out from the electronic tag 10 before being attached to the object 50, or the retained information 51 may be acquired from the object 50 before the electronic tag 10 is attached thereto, and the second identification information may be acquired on the basis of the retained information 51.

### Second Example

FIG. 2 illustrates a configuration example in which the electronic tag inspection system 1 of the first example is combined to the electronic tag attachment system 2 including the tag attachment unit 40 that attaches the electronic tag 10 to which the first identification information is written. The electronic tag attachment system 2 in FIG. 2(a) is combined to the electronic tag inspection system 1 in FIG. 1(a), and the electronic tag attachment system 2 in FIG. 2(b) is combined to the electronic tag inspection system 1 in FIG. 1(b). According to this, after attaching the electronic tag 10 to the object 50, inspection for mismatching between the electronic tag 10 and the object 50 can be performed.

In this case, as in the illustrated example, when installing the conveyance line 30 that conveys the object 50, the tag attachment unit 40 that attaches the electronic tag 10 to which the first identification information is written to the object 50 on the conveyance line 30 is provided, and the reading device 60 and the acquisition unit 70 are installed downstream of the tag attachment unit 40 in the conveyance line 30, the electronic tag 10 is attached to the object 50 on the conveyance line 30 while conveying the object 50, and then the first identification information and the second identification information are read out. According to this, the electronic tag 10 can be continuously attached to a plurality of the objects 50, and inspection for mismatching therebetween can be simultaneously performed. The inspection result is output to an output device such as the display device 82 by the control unit 100. In addition to this, when detecting mismatching by the detection unit 90, the conveyance line 30 can be stopped by the control unit 100.

Although not illustrated in the drawings, the acquisition unit 70 can be provided upstream of the attachment position by the attachment unit 40 in the conveyance line 30.

The conveyance line 30 may continuously convey the object 50 from a position of the tag attachment unit 40 to an inspection position of the electronic tag inspection system 1 as illustrated in FIG. 2(a), or the conveyance line 30 may be individually installed in each of the tag attachment unit 40 and the electronic tag inspection system 1, and may non-continuously convey the object 50 between the tag attachment unit 40 and the electronic tag inspection system 1 as illustrated in FIG. 2(b). In the case of this example, the stationary type one device E0 is preferable as a whole, but the storage unit 80 can be set as another device and can also be installed to be spaced apart from the other devices.

The other configurations are basically similar as in the first example.

### Third Example

FIG. 3 is similar to the second example in that the electronic tag inspection system 1 is combined to the electronic tag attachment system 2 including the tag attachment unit 40 that attaches the electronic tag 10 to which the first identification information is written. However, the third example is different from the second example in that the acquisition unit 70 acquires the second identification information from the object 50 before attachment of the electronic tag 10, and the reading device 60 reads out the first identification information from the electronic tag 10 before being attached to the object 50. Accordingly, mismatching between the electronic tag 10 and the object 50 can be detected before attachment of the electronic tag 10, and thus the electronic tag 10 is not wasted, and a concern about breakage of the exterior of the object 50 also disappears.

In this case, as in the illustrated example, the conveyance line 30 such as a conveyor that conveys the object 50 can be installed, the acquisition unit 70 that acquires the second identification information from the object 50 on the conveyance line 30 can be installed, the tag attachment unit 40 that attaches the electronic tag 10 to which the first identification information is written can be installed downstream of the acquisition unit 70, and the reading device 60 that reads out the first identification information from the electronic tag 10 before being attached to the object 50 can be installed in the tag attachment unit 40.

In the case of this example, the stationary type one device E0 is preferable as a whole, but the storage unit 80 can be set as another device as illustrated in FIG. 3(b) and can also be installed to be spaced apart from the other devices.

In this example, when mismatching is detected by the detection unit 90, it is preferable to stop the conveyance line 30 or an operation of the tag attachment unit 40 by the control unit 100 so that the tag attachment unit 40 cannot attach the electronic tag 10 to the object 50. In this case, the device can be restarted after modifying any one of the electronic tag 10 and the object 50 to correctly match each other.

The other configurations are basically similar as in the first example and the second example.

### Other Examples

A partial configuration of each of the first example to the third example is applicable to another example within a range not deteriorating a basic configuration of the other examples. In addition, a partial configuration of the application example to be described later is also applicable to the first example to the third example within a range not deteriorating the basic configuration thereof. For example, only the tag attachment unit 40 in the application example to be described later may be omitted, and inspection on the object 50 to which the electronic tag 10 is attached in advance may be performed, and a mismatched object may be discharged by the discharge device 35.

### Application Example of Electronic Tag Attachment System

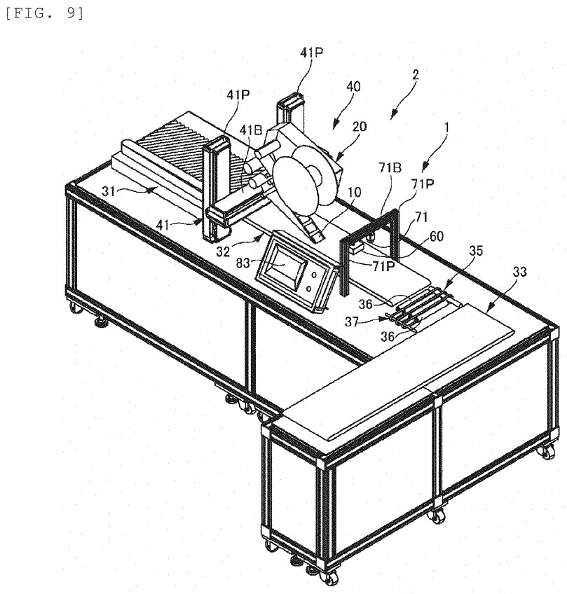

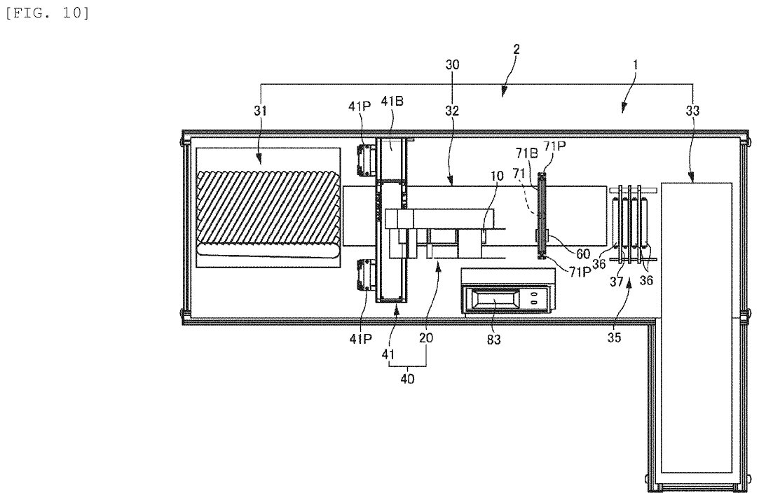

FIG. 9 and FIG. 10 illustrate the electronic tag attachment system 2 to which the second example is applied. The electronic tag attachment system 2 is configured to stick the electronic tag 10 having the adhesive surface 11 to the object 50 such as a product, and includes the conveyance line 30 that conveys the object 50, and an attachment unit 40 that sticks the electronic tag 10 to which the first identification information is written to the object 50 on the conveyance line 30. In addition, the electronic tag attachment system 2 is provided with the electronic tag inspection system 1 that performs inspection for mismatching between the electronic tag 10 and the object 50 downstream of the attachment unit in the conveyance line 30. That is, the electronic tag inspection system 1 includes the reading device 60 that is installed downstream of the tag attachment unit 40 in the conveyance line 30 and reads out the first identification information written to the electronic tag 10, the acquisition unit 70 that is installed downstream of the tag attachment unit 40 in the conveyance line 30 and acquires the second identification information on the basis of information retained by the object 50 that is an attachment target of the electronic tag 10, and the above-described detection unit 90 (not illustrated in FIG. 9 and FIG. 10) that compares the first identification information and the second identification information and detects a difference therebetween as mismatching between the electronic tag 10 and the object 50.

Details of the first identification information, the second identification information, the detection unit 90, the acquisition unit 70, the control unit 100 of the system, and the like are the same as described above.

In this electronic tag attachment system 2, when a worker, a robot, or other supply devices put the object 50 on the conveyance line 30, the electronic tag 10 can be automatically stuck to the object 50 on the conveyance line 30 by the attachment unit in a process of conveying the object 50 by the conveyance line 30. In addition, in this electronic tag attachment system 2, since the first identification information and the second identification information are read out after sticking the electronic tag 10, mismatching can be inspected simultaneously with continuous attachment of the electronic tag 10 to a plurality of the objects 50. Hereinafter, respective units will be sequentially described.

(Attachment Unit)

As the attachment unit 40, a sticking device using a robot, or the like can be used without particular limitation as long as the electronic tag 10 can be sequentially stuck to the object 50 that is being conveyed by the conveyance line 30. In the illustrated example, a cheaper attachment unit 40 is employed, and the attachment unit 40 includes a labeler 20 that sequentially sticks the electronic tag 10 to a plurality of the objects 50 conveyed in a predetermined movement trajectory at a predetermined sticking position in the conveyance line 30, and a movement device 41 that moves the labeler 20.

(Labeler)

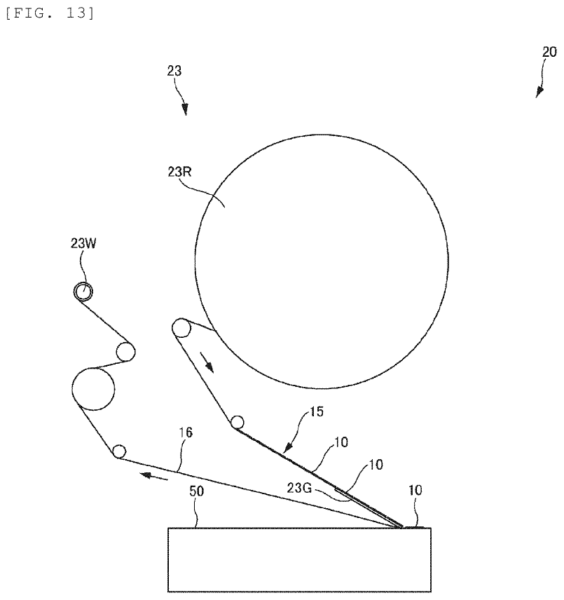

The labeler 20 is not particularly limited, but FIG. 13 illustrates an example of the labeler 20 that is used in a state where an electronic tag roll 23R (supply body) is attached. The electronic tag roll 23R is obtained by winding a continuous strip-shaped electronic tag sheet 15 into a roll shape, and the electronic tag sheet 15 includes a plurality of the electronic tags 10 which are repeatedly stuck in a continuous direction of a continuous strip-shaped release sheet 16 with predetermined intervals. The same first identification information is written to all of the electronic tags 10 of the same electronic tag roll 23R, the electronic tags 10 having writing information corresponding to the objects 50 can be automatically and sequentially struck to a plurality of the same objects 50 by replacing the electronic tag roll 23R in correspondence with the kind of the objects 50. The electronic tag roll 23R is rotatably supported to a rotational shaft (not illustrated).

In this labeler 20, the electronic tag sheet 15 unwound from the electronic tag roll 23R is intermittently conveyed at timing of being stuck to each of the objects 50, and is conveyed to a folding-back guide 23G (may be a rotating shaft or a non-rotating shaft in addition to plate shape as in the illustrated example). In the folding-back guide 23G, the release sheet 16 is guided to be folded back to a side opposite to a side where the electronic tags 10 are provided. In addition, at the time of the folding-back, each of the electronic tags 10 having rigidity is naturally peeled off from the release sheet 16, and is stuck to the object 50. Although not illustrated in the drawings, a roller that presses the electronic tag 10 stuck to the object 50 or an air attachment device is also preferably provided. The release sheet 16 that remains after the electronic tag 10 is peeled off is wound around a winding shaft 23W. The winding shaft 23W is rotatably driven by a stepping motor (not illustrated), and the electronic tags 10 are intermittently wound to be peeled off from the release sheet 16 sheet by sheet and to be stuck to the objects 50 at timing of being stuck to the objects 50.

The timing of sticking the electronic tag 10 to the objects 50 can be appropriately determined. For example, an object sensor (not illustrated) that detects the objects 50 may be installed at a sticking position by the labeler 20 or in the vicinity of the sticking position, and the electronic tag 10 may be stuck to the objects 50 at appropriate timing determined on the basis of the detection timing. As the object sensor, a known contact type sensor in addition to a known non-contact type sensor such as a transmission type sensor and a reflection type sensor can also be used.

(Movement Device)

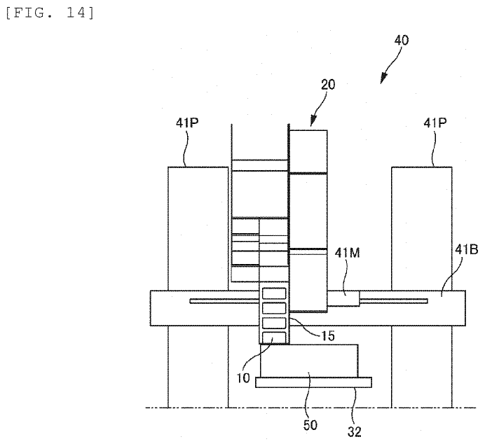

The movement device 41 is not particularly limited. For example, in addition to the configurations illustrated in FIG. 9 and FIG. 10, as illustrated in FIG. 14, the movement device 41 includes a pair of support columns 41P installed in both sides of a CD direction of the conveyance line 30, a beam 41B that is stretched between the support columns 41P and is supported to the support columns 41P to ascend and descend, a movable body 41M that is supported to the beam 41B to reciprocate in the CD direction, a drive device (not illustrated) that drives the beam 41B to ascend and descend, and a driving device (not illustrated) that operates the movable body 41M to reciprocate. The labeler 20 is attached to the movable body 41M. Accordingly, the labeler 20 can adjust a sticking position in the CD direction by reciprocation of the movable body 41M, and can adjust a sticking height by ascendance and descendance of the beam 41B.

The movement device 41 may be operated while checking a position of the labeler 20 by a worker, but it is preferable that the movement device 41 includes a storage unit 80 that stores designation information for designating the object 50 and a sticking position in association with each other, and an input device 81 that designates the object 50, and in correspondence with the object 50 input by the input device 81, a corresponding sticking position is read out from the storage unit 80, and a sticking position of the tag attachment unit 40 is automatically changed to the sticking position read out from the storage unit 80 by the movement device 41. Note that, the storage unit 80 and the input device 81 are as described above, but in the illustrated example, a touch panel display 83 in which the input device 81 and a display device 82 are integrated is provided, and an object designation input is performed by touching an object designation button displayed on the display device 82, or the like.

(Conveyance Line)

Although not illustrated in the drawings, the conveyance line 30 can also be constituted by only one conveyor in addition to a configuration in which a plurality of conveyors 31 to 33 are connected as in the illustrated example. As the conveyors 31 to 33, all known conveyors can be used as long as a movable body is moved in a conveying direction and the object 50 on the movable body can be conveyed, and for example, a belt conveyor, a plate conveyor, or the like in which an upper surface is a loading surface can be appropriately used. It is preferable that the conveyors 31 to 33 have the loading surface having a width wider than a width of the objects 50, for example, in order for a worker to load the objects 50 of many kinds different in a size without being conscious of a position or a direction of the objects 50. Of course, the conveyors 31 to 33 may have a configuration in which the kind and the loading position (including a direction) of the objects 50 are constant. In addition, the objects 50 can also be mechanically loaded on the conveyors 31 to 33.

In a case where the attachment unit 40 performs continuous processing at a predetermined sticking position as in the above-described combination of the labeler 20 and the movement device 41, when an aligning conveyor 31 is installed upstream of the attachment unit 40 in the conveyance line 30, an inspection conveyor 32 that reaches to a downstream side in comparison to the reading device 60 and the acquisition unit 70 through the attachment unit 40 is connected to a downstream side of the aligning conveyor 31, and the objects 50 are passed through the attachment unit 40 by the inspection conveyor 32 after the position of the objects 50 made constant in the CD direction, the electronic tag 10 can be stuck to a predetermined sticking position, and thus this configuration is preferable.

In the conveyance line 30, it is preferable that the objects 50 are continuously conveyed at a constant speed, but the conveyance line 30 may be intermittently driven with a standby time at an appropriate position to match various kinds of timing such as sticking timing of the electronic tag 10.

When mismatching is detected by the detection unit 90, the device can also be stopped. However, it is preferable that the discharge device 35 that discharges the objects 50 is installed on a downstream side of the reading position of the reading device 60 and the acquisition position of the acquisition unit 70 in the conveyance line 30, and when mismatching is detected by the detection unit 90, the control unit 100 operates the discharge device in order for an object 50 corresponding to the mismatching to be discharged from the conveyance line 30. According to this, it is possible to reliably discriminate the object 50 corresponding to the mismatching and the objects 50 corresponding to normal attachment.

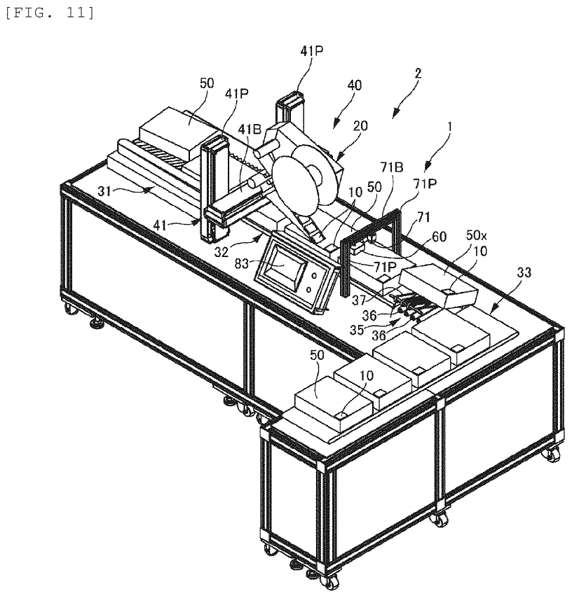

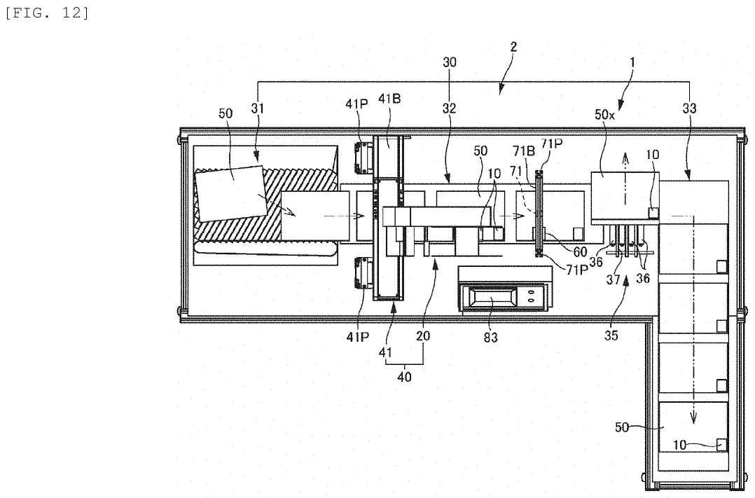

With regard to the discharge device 35, a known technology of discharging a defective product from the conveyance line 30 can be used without particular limitation. The discharge device 35 in the illustrated example discharges the object 50 to a lateral side of the conveyance line 30 on a downstream side of the reading position of the reading device 60 and the acquisition position of the acquisition unit 70 in the conveyance line 30. The discharge device 35 includes three or more lateral drive rollers 36 and discharge slopes 37, each being disposed with an interval in the MD direction. The drive roller 36 is driven by a driving source (not illustrated) and conveys the objects 50 from the upstream side inspection conveyor 32 to the downstream side normal product conveyor 33. Each of the discharge slopes 37 is a trapezoidal member supported to swing by a support shaft on one side of the drive roller 36 in the CD direction, and can swing by a driving device (not illustrated) controlled by the control unit 100 between a first position (position illustrated in FIG. 9 and FIG. 10) hidden between the drive rollers 36, and a second position (position illustrated in FIG. 11 and FIG. 12) that is inclined from the one side to the other side in the CD direction on an upward side in comparison to the drive roller 36.

(Acquisition Unit)

The acquisition unit 70 in this example includes the retained information sensor 71 installed between the attachment unit 40 and the discharge device 35 in the conveyor. In a case where the discharge device 35 is not provided, the retained information sensor 71 can be installed at an arbitrary position on a downstream side of the attachment unit 40. In addition, the retained information sensor 71 in the illustrated example is installed on an upward side of the conveyor, and acquires retained information 51 on an upper surface of the object 50, but the retained information sensor 71 can be disposed at an appropriate position in correspondence with a position of the retained information 51 of the object 50. For example, the retained information sensor 71 may be disposed on a lateral side of the conveyor to acquire the retained information 51 on a lateral side of the object 50.

As in the labeler 20, in the retained information sensor 71, at least one of a position and a height in the CD direction can be adjusted by the movement device 41, but may be manually adjusted as in the illustrated example. That is, in the illustrated example, the pair of support columns 71P are installed on both sides of the CD direction of the conveyor, the beam 71B is stretched between the support columns 71P, and the retained information sensor 71 is screwed downward to the beam 71B that crosses over the conveyor.

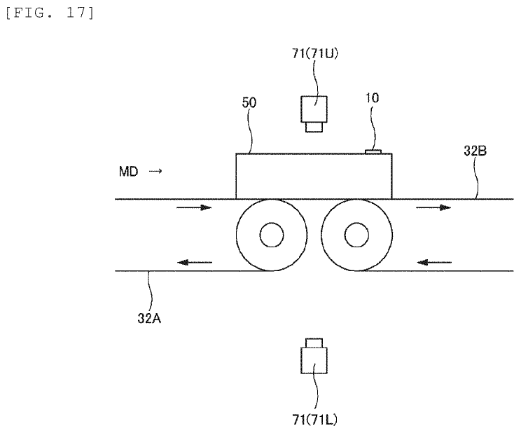

It is preferable that the retained information sensor 71 can detect all surfaces of the object 50. According to this, in the case of performing detection by the retained information sensor 71 while conveying the object 50 by the conveyance line 30, a device configuration illustrated in FIG. 17 or the like is also preferable. That is, the inspection conveyor 32 is constituted by a first conveyor 32A, and a second conveyor 32B that is continuous to a downstream side of the first conveyor 32A with a gap and receives and conveys the object 50 conveyed from the first conveyor 32A, and the retained information sensor 71 includes a lower sensor 71L that detects the retained information 51 of the object 50 from a downward side of the object 50 through the gap between the first conveyor 32A and the second conveyor 32B, and an upper sensor 71U that detects the retained information 51 of the object 50 from an upward side of the object 50 on an upstream side of a sticking possible range of the robot.

In this manner, when using the gap in a delivery portion between the first conveyor 32A and the second conveyor 32B, the retained information of the object 50 can be detected from both the upward side and the downward side, and thus it is possible to continuously process a plurality of kinds of objects 50 in which positions of the retained information in the objects 50 are vertically different without being conscious of the vertical direction.

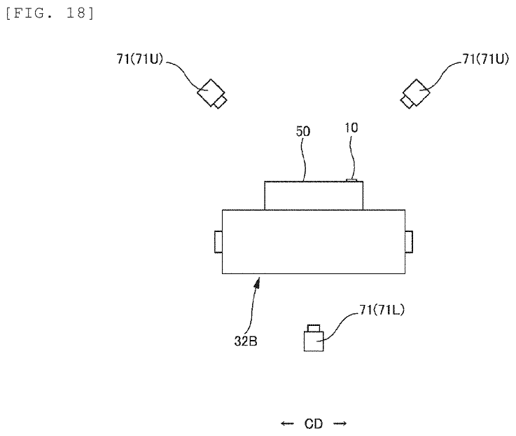

Particularly, in a case where detection in a wide range is possible by using an imaging sensor as the retained information sensor 71, as illustrated in FIG. 18, it is preferable to install the upper sensor 71U that performs detection from a diagonally upper side on one side of the CD direction, the upper sensor 71U that performs detection from a diagonally upper side on the other side of the CD direction, and the lower sensor 71L that performs detection from an immediately below side because four surfaces of the object 50 can be detected by the three sensors. That is, as illustrated in FIGS. 10(a), 10(b), and 10(c), even though the retained information 51 exists on any of an upper surface, a side surface, and a lower surface of the object 50, the retained information can be detected. Note that, an MD direction represents a mechanical direction (conveyance direction), and the CD direction represents a lateral direction orthogonal to the MD direction.

Acquisition timing of the second identification information by the retained information sensor 71 can be appropriately determined in accordance with the kind of the retained information sensor 71. For example, in a case where an imaging sensor capable of performing continuous imaging (including both continuous shooting of a still image and moving image photographing) at a sufficient speed is used as the retained information sensor 71, presence or absence of the retained information can be always monitored and the retained information can be detected by subjecting imaging data to image recognition processing. Of course, the retained information sensor 71 may be operated only when an object reaches the retained information sensor 71. For example, an object sensor (not illustrated) that detects the object 50 may be installed at the acquisition position of the second identification information by the retained information sensor 71 or in the vicinity of the acquisition position, and the retained information sensor 71 may be operated at appropriate timing determined on the basis of detection timing of the object sensor. As the object sensor, a known contact type sensor in addition to a known non-contact type sensor such as a transmission type sensor and a reflection type sensor can also be used. As described above, in a case where the object sensor is installed at the sticking position by the labeler 20 or in the vicinity of the sticking position, the object sensor may be used for timing acquisition of the second identification information by the retained information sensor 71, and the object sensor may not be installed at the acquisition position of the second identification information by the retained information sensor 71 or in the vicinity of the acquisition position.

(Reading Device)

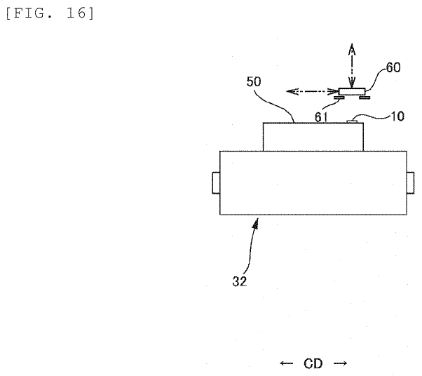

The reading device 60 is installed between the attachment unit 40 and the discharge device 35 in the conveyance line 30. In a case where the discharge device 35 is not provided, the reading device 60 can be installed at an arbitrary position on a downstream side of the attachment unit 40. The reading device 60 in the illustrated example is attached to the same beam 71B as in the retained information sensor 71, but may also be installed on a downstream side or an upstream side of the retained information sensor 71. A readable area of the reading device 60 is wide unlike the retained information sensor 71, and thus an installation position of the reading device 60 may be a position other than an upward side or a lateral side of the conveyor. In addition, the position of the reading device 60 may be manually adjusted as in the acquisition unit, but at least one of a position and a height in the CD direction may be adjustable by the same movement device as in the labeler 20 as illustrated in FIG. 16.

It is preferable to install a shielding body 61 (mask) that shields a space between the reading device 60 and an electronic tag 10 that is not a reading target as illustrated in FIG. 16 so as to limit a communication range of the reading device 60, thereby limiting a communication range of the reading device 60 to one electronic tag 10. The shielding body 61 can be formed by using a material such as a metal plate that shields electronic waves, and a shape thereof is not particularly limited. For example, the material may be a plate or foil in which a hole exists between the reading device 60 and a predetermined reading position, and a hole does not exist at the periphery of the predetermined reading position.

The acquisition timing of the first identification information by the reading device 60 can be appropriately determined. For example, an object sensor (not illustrated) that detects the object 50 may be installed at the acquisition position of the first identification information by the reading device 60 or in the vicinity of the acquisition position, and the reading device 60 can be operated at appropriate timing determined on the basis of detection timing of the object sensor. As the object sensor, a known contact type sensor may also be used in addition to a known non-contact type sensor such as a transmission type sensor and a reflection type sensor. As described above, in a case where the object sensor is installed at the sticking position by the labeler 20 or in the vicinity of the sticking position, and at the acquisition position of the second identification information by the retained information sensor 71 or in the vicinity of the acquisition position, any one of the target sensors may be used for timing acquisition of the first identification information by the reading device 60, and the object sensor may not be installed at the acquisition position of the first identification information by the reading device 60 or in the vicinity of the acquisition position.

<Flow of Operation of Application Example>

When using the attachment device of this electronic tag 10, first, a worker designates the object 50 by the touch panel display 83. According to this, the control unit 100 reads out a sticking position of the object 50 that is input from the storage unit 80, and operates the movement device 41 to move the labeler 20 to a sticking position (for example, a position corresponding to the object 50 illustrated in FIG. 14). In addition, the worker or the like attaches the electronic tag roll 23R to which the first identification information corresponding to the object 50 is written to the labeler 20.

After the above-described preparation is completed, when the worker inputs sticking initiation by the input device 81, the control unit 100 receiving the input starts the conveyor and thus attachment of the electronic tag 10 can be initiated. As illustrated in FIG. 11 and FIG. 12, the worker sequentially puts the same objects 50 (the same products) on an upstream side of the labeler 20 in the conveyance line 30. According to this, first, the electronic tag 10 is stuck to each of the objects 50 in the labeler 20, and then the object 50 passes through the reading device 60 and the acquisition unit 70. At this time, the first identification information is detected by the reading device 60, the second identification information is acquired by the acquisition unit 70, and the two pieces of information are input to the detection unit 90.

The detection unit 90 compares the first identification information and the second identification information with each other. As a result, in a case where the two pieces of information match each other, since the electronic tag 10 and the object 50 match each other, the object 50 is moved as is to the normal product conveyor 33 after passing through the discharge device 35, and is conveyed by the normal product conveyor 33. Normal products may be taken out from the normal product conveyor 33 by the worker, or may be discharged by a robot or an appropriate discharge device 35.

On the other hand, as a result of the comparison between the first identification information and the second identification information by the detection unit 90, in a case where the two pieces of information are different from each other, this corresponds to mismatching between the electronic tag 10 and the object 50, and thus the object 50 is discharged to the outside of the conveyance line 30 by the discharge device 35, and is not moved to the normal product conveyor 33. That is, in the case of the discharge device 35 in the illustrated example, when mismatching is not detected by the detection unit 90, the discharge slopes 37 are held to the first position (position illustrated in FIG. 9 and FIG. 10), and the object 50 is moved to the normal product conveyor 33 connected to the downstream side by the drive roller 36. On the other hand, the mismatching is detected by the detection unit 90, the result is input to the control unit 100, and the control unit 100 operates the discharge device 35 to lift up the discharge slopes 37 to the second position (position illustrated in FIG. 11 and FIG. 12) at timing at which a mismatched object 50x is located over the discharge slopes 37, thereby lifting up the mismatched object 50x from the drive rollers 36 to slide down from a side on the discharge slopes 37 to a lateral side of the conveyance line 30. Then, the discharge slopes 37 are returned to the first position (position illustrated in FIG. 9 and FIG. 10).

In addition, in a case where the first identification information cannot be detected by the reading device 60, the electronic tag 10 is not attached to the object 50. That is, in the case of this electronic tag attachment system 2, the attachment device fails to attach the electronic tag 10. Even in this case, the first identification information and the second identification information do not match each other. Absolutely, when the first identification information cannot be detected by the reading device 60, comparison between the first identification information and the second identification information is not performed, and the same processing as in the case of mismatching can be performed. In addition, even in a case where the second identification information cannot be acquired by the acquisition unit 70, the same processing as in a case where the first identification information cannot be detected by the reading device 60 can be performed.

In this manner, the electronic tag 10 can be continuously attached to a plurality of the objects 50 and mismatching therebetween can be inspected.

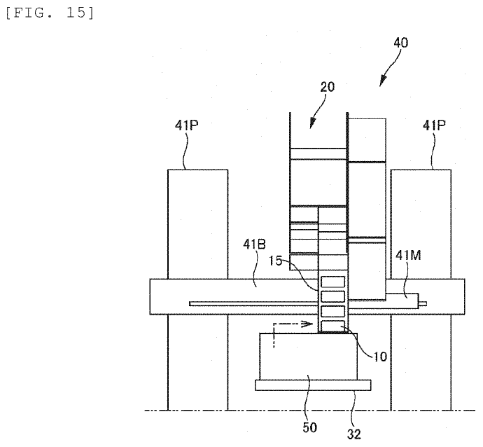

When the object 50 is changed, the worker or the like replaces the electronic tag roll 23R attached to the labeler 20 with an electronic tag roll 23R to which corresponding first identification information is written. In addition, designation of the object 50 is performed again by the input device 81. According to this, for example, the position of the labeler 20 is changed from a position corresponding to the object 50 illustrated in FIG. 14 to a position corresponding to the subsequent object 50 as indicated by an arrow in FIG. 15. The subsequent processing is similar to the above-described case.

### INDUSTRIAL APPLICABILITY

The invention can be used to perform inspection for mismatching between an electronic tag and an object when attaching the electronic tag to the object such as a product or after attaching the electronic tag to the object.

### REFERENCE SIGNS LIST

1 Electronic tag inspection system
2 Electronic tag attachment system
10 Electronic tag
10a, 10i Inlet
10a Antenna
10i IC chip
11 Adhesive surface
12 Non-adhesive portion
13 Residual adhesive portion
15 Electronic tag sheet
16 Release sheet
20 Labeler
23G Folding-back guide
23R Electronic tag roll
23W Winding shaft
30 Conveyance line
31 Aligning conveyor
32 Inspection conveyor
33 Normal product conveyor
35 Discharge device
36 Drive roller
37 Discharge slope
40 Attachment unit
41 Movement device
41P Support column
41B Beam
41M Movable body
50 Object
51 Retained information
60 Reading device
70 Acquisition unit
71 Retained information sensor
71L Lower sensor
71U Upper sensor
80 Storage unit
81 Input device
82 Display device
83 Touch panel display
90 Detection unit
100 Control unit
E1 First device
E2 Second device
E0 One device

1-8. (canceled)

9. An electronic tag attachment system comprising:
a conveyance line that conveys an object that is an attachment target of an electronic tag;
a tag attachment unit that attaches the electronic tag to which first identification information is written to the object on the conveyance line;
a reading device that reads out the first identification information written to the electronic tag from the electronic tag attached to the object on the conveyance line on a downstream side of the tag attachment unit in the conveyance line;
an acquisition unit that acquires second identification information on the basis of information retained by the object that is the attachment target of the electronic tag from the object on the conveyance line on a downstream side of the tag attachment unit in the conveyance line; and
a detection unit that compares the first identification information and the second identification information and detects a difference therebetween as mismatching between the electronic tag and the object.

10. The electronic tag attachment system according to claim 9, further comprising:
a discharge device that discharges the object on a downstream side in comparison to a reading position of the reading device and an acquisition position of the acquisition unit in the conveyance line,
wherein when the mismatching is detected by the detection unit, an object of the mismatching is discharged from the conveyance line by the discharge device.

11. The electronic tag attachment system according to claim 9,
wherein the tag attachment unit includes a supply body including a plurality of the electronic tags to which the same first identification information is written, and sequentially attaches the electronic tags of the supply body to the objects, and
the supply body is replaceable.

12. The electronic tag attachment system according to claim 9,
wherein the electronic tag includes an adhesive portion to be stuck to the object,
the electronic tag attachment system has a conveyance line that conveys the object to draw a predetermined movement trajectory,
the tag attachment unit,
sticks the electronic tag to the object at a predetermined sticking position in the conveyance line, and
includes a movement device that moves the sticking position,
a storage unit that stores designation information for designating the object, and the sticking position in association with each other, and
an input device that designates the object, and
a corresponding sticking position is read out from the storage unit in correspondence with the object input by the input device, and the sticking position of the tag attachment unit is automatically changed to the sticking position read out from the storage unit by the movement device.

13. An electronic tag inspection system comprising:
a reading device that reads out first identification information written to an electronic tag;
an acquisition unit that acquires second identification information on the basis of information retained by an object that is an attachment target of the electronic tag; and
a detection unit that compares the first identification information and the second identification information and detects a difference therebetween as mismatching between the electronic tag and the object.

14. An electronic tag inspection method comprising:
a reading step of reading out first identification information written to an electronic tag;
an acquisition step of acquiring second identification information on the basis of information retained by an object that is an attachment target of the electronic tag; and
a detection step of comparing the first identification information and the second identification information and of detecting a difference therebetween as mismatching between the electronic tag and the object.
